(19) United States
(12) Patent Application Publication
(10) Pub. No.: US 2006/0128892 A1
(43) Pub. Date: Jun. 15, 2006

(54) Ductile and transparent thermoplastic compositions comprising an amorphous matrix and a block copolymer

(76) Inventors: Manuel Hidalgo, Lyon (FR); Silvija Abele, Riga (LV); Francois Court, Paris (FR); Ludwik Leibler, Paris (FR); Djamel Bensarsa, Sainte Fay Les Lyon (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 10/532,385

(22) PCT Filed: Oct. 15, 2003
(86) PCT No.: PCT/FR03/03031

§ 371 Date: Oct. 13, 2005

(30) Foreign Application Priority Data
Oct. 21, 2002 (FR) 02/13054

(51) Int. Cl. C08L 53/00; B32B 27/20

(52) U.S. Cl. 525/89; 525/88; 428/221

(57) ABSTRACT

The invention concerns transparent materials having good impact resistance, a high modulus and good heat resistance. The inventive materials comprise an amorphous matrix, preferably based on styrene/methyl methacrylate statistical copolymer whether impact-reinforced of not with a standard additive, and a block copolymer having at least an elastomeric block and at least a block partly or entirely compatible with the amorphous matrix.

This application claims benefit, under U.S.C. § 119 or §365 of French Application Number 02/13054, filed Oct. 21, 2002; and PCT/FR2003/003031 filed Oct. 15, 2003.

### FIELD OF THE INVENTION

The present invention relates to the field of transparent polymeric materials, and particularly to the field of transparent materials combining good transparency, impact strength, a high modulus, and good heat resistance.

Materials of the invention may be used in the application fields of polymeric materials that require transparency and/or good mechanical properties. In particular the materials of the invention may be used in the construction, household electrical appliance, telephony and office automation sectors and in the automobile industry.

Generally speaking, amorphous thermoplastic polymeric materials are transparent and have a high mechanical modulus, but their impact strength is low. These are generally homopolymers or copolymers (such as polymethyl methacrylate, polystyrene or poly[styrene-co-acrylonitrile]) whose glass transition temperature (Tg) is close to 100° C. and whose tensile mechanical behavior is that of fragile materials. For this reason, and for certain applications, it is sometimes necessary to formulate them with additives able to provide improved impact strength. However, when the amorphous thermoplastic polymeric materials are formulated or are blended with other products, particularly with conventional impact additives, they lose certain properties, in particular in terms of transparency and mechanical modulus, but also in terms of heat resistance.

In effect, although the possibility exists of having an amorphous thermoplastic polymeric material that is both impact-resistant and transparent, it is still difficult, if not impossible, to obtain at one and the same time transparency, impact strength, a high modulus, and good heat resistance.

The problem that the invention aims to solve is to develop a transparent polymeric composition combining all of the aforementioned properties.

Although there are many documents which describe the impact toughening of amorphous thermoplastic polymers, none of them has succeeded in solving, or in proposing an approach to solving, the problem set out above, namely that of combining good impact strength with a high mechanical modulus. Even more notable is the ability to combine this impact/modulus tradeoff with an improved heat resistance.

The applicant has found that the solution to this problem is a polymeric composition comprising a matrix based on an amorphous thermoplastic polymer, impact-toughened or otherwise, and a judiciously selected block copolymer.

According to the invention the block copolymer must have an elastomeric block and at least one block which is totally or partially compatible with the amorphous matrix. Moreover, the difference in refractive index of the matrix, n₁, and that of the block copolymer must be less than or equal to 0.01. Where the matrix is already impact-toughened with a conventional impact additive, the difference between the refractive index of the matrix and that of the additive must also be less than or equal to 0.01. In the latter case, therefore, the composition according to the invention comprises three components—matrix, conventional impact additive, and block copolymer—whose respective refractive indices must not differ from one another by more than 0.01.

Transparency is assured by the adjustment of the refractive indices. The elastomeric block of the block copolymer provides the impact strength, by making the fragile matrix ductile. The judicious selection of the other blocks of the block copolymer allows the transparency to be retained, allows a high modulus, and allows the heat resistance to be preserved or improved.

The invention first provides a transparent polymeric composition having good impact strength, a high modulus, and good heat resistance, composed of

from 50% to 90% by weight of a thermoplastic matrix (I) with a refractive index n₁,

from 0 to 40% by weight of an impact additive (II) with a refractive index n₂, and

from 10% to 50% by weight of a block copolymer (III) with a refractive index n₃.

The difference between the refractive indices, taken two by two, is less than or equal to 0.01.

The copolymer (III) must have an elastomeric block (B) and at least one block which is totally or partially compatible, in the thermodynamic sense, with the amorphous matrix.

Component (I) may be a homopolymer or a copolymer selected from the polymers obtained by polymerizing at least one monomer selected from the group consisting of styrene, acrylonitrile, acrylic acid, and short-chain alkyl (meth)acrylates such as methyl methacrylate.

The monomers mixture is selected so as to have an amorphous, rigid and transparent compound (I) and to have the desired refractive index. The polymerization is conducted in accordance with the customary techniques of polymerization in bulk, in solution or in a disperse medium such as in suspension, emulsion, precipitation polymerization, etc.

According to one preferred embodiment of the invention compound I is a random copolymer of styrene and methyl methacrylate containing from 0 to 55% by weight of styrene. This compound (I) is referred to hereinafter as SM.

Additive (II): This is a “core-shell” additive commonly used for the impact modification of matrices such as PVC, epoxy resins, poly(styrene-co-acrylonitrile) or SAN, etc. Additives known as “core-shell” additives are structured polymers obtained, in general, by emulsion polymerization in two steps, the first step serving to produce the “core”, which is used as the seed for a second step intended for the production of the “shell”. The “core” is usually a polymer (or copolymer) having a Tg which is lower than ambient temperature, and is therefore in the rubbery state. Typically the “core” may be composed of a crosslinked or non-crosslinked random copolymer of butadiene and styrene. “Cores” based on polybutadiene alone or on copolymers of butadiene and acrylonitrile, or purely acrylic “cores” based on copolymers of butyl acrylate and styrene, constitute other examples. The “shell” is intended to envelop the “core” and to provide it with ease of dispersion in the matrix. Typical “shells” are those based on poly(methyl methacrylate), copolymers of methyl methacrylate and styrene, purely acrylic copolymers, copolymers of styrene and acrylonitrile, etc. One of these conventional impact additives is MBS, which constitutes a preferred impact additive of the invention; it is a “core-shell” additive with a random butadiene-styrene copolymer “core” and a “shell” of PMMA or of a random methyl methacrylate-styrene copolymer. The MBS used in the examples below is a grade for PVC, having a “core” refractive index of close to 1.54 at ambient temperature.

Component (III) is a block copolymer conforming to the following general formula -Y-B-Y′- in which B is an elastomeric block, Y and Y′ may be identical or nonidentical in chemical composition, and at least one of the two is at least partially compatible with the compound (I). The blocks Y and Y′ are thermodynamically incompatible with the block B.

The monomer used to synthesize the elastomeric block B may be a diene selected from butadiene, isoprene, 2,3-dimethyl-1,3-butadiene, 1,3-pentadiene and 2-phenyl-1,3-butadiene. B is selected advantageously from poly(dienes), particularly poly(butadiene), poly(isoprene) and their random copolymers, or else from partially or completely hydrogenated poly(dienes). Among the polybutadienes use is made advantageously of those whose glass transition temperature, Tg, is the lowest; for example, polybuta-1,4-diene with a Tg (around −90° C.) which is lower than that of polybuta-1,2-diene (around 0° C.). The blocks B may also be hydrogenated. This hydrogenation is carried out according to customary techniques.

Preferably the blocks B are composed predominantly of polybuta-1,4-diene.

Advantageously the Tg of B is less than 0° C. and preferably less than −40° C.

Y and Y′ may be obtained by polymerizing at least one monomer selected from the group consisting of styrene and short-chain methacrylates such as methyl methacrylate. However, if Y is a block composed predominantly of styrene, then Y′ is other than a block composed predominantly of styrene.

Preferentially Y′, denoted hereinafter by M, is composed of methyl methacrylate monomers or contains at least 50% by mass of methyl methacrylate, preferably at least 75% by mass of methyl methacrylate. The other monomers making up this block may be acrylic or nonacrylic monomers and may be reactive or nonreactive. Nonlimiting examples of reactive functions that may be mentioned include oxirane functions, amine functions, and carboxyl functions. The reactive monomer may be a hydrolysable monomer, leading to acids. Among the other monomers which may make up the block Y′ mention may be made, by way of nonlimiting example, of glycidyl methacrylate and tert-butyl methacrylate.

Advantageously M is composed of syndiotactic polymethyl methacrylate (PMMA) to an extent of at least 60%.

When Y is different in chemical composition from Y′, as in the case of the examples below, Y is denoted by S. This block may be obtained by the polymerization of vinylaromatic compounds such as, for example, styrene, α-methylstyrene, and vinyltoluene. The Tg of Y (or S) is advantageously greater than 23° C. and preferably greater than 50° C.

The block copolymer, Y-B-Y′, according to the invention is denoted hereinafter by SBM.

According to the invention the SBM has a number-average molar mass which may be between 10 000 g/mol and 500 000 g/mol, preferably between 20 000 and 200 000 g/mol. The SBM triblock advantageously has the following composition, expressed as mass fractions, the total being 100%:

M: between 10% and 80% and preferably between 15% and 70%.

B: between 2% and 80% and preferably between 5% and 70%.

S: between 10% and 88% and preferably between 5% and 85%.

According to the invention the SBM may include at least one diblock S-B in which the blocks S and B have the same properties as the blocks S and B of the S-B-M triblock. They are composed of the same monomers and, where appropriate, comonomers as the blocks S and the blocks B of the S-B-M triblock. Likewise, the blocks B of the S-B diblock are composed of monomers selected from the same class as the class of monomers available for the blocks B of the S-B-M triblock.

The S-B diblock has a number-average molar mass which may be between 5000 g/mol and 500 000 g/mol, preferably between 10 000 and 200 000 g/mol. The S-B diblock is advantageously composed of a mass fraction of B of between 5% and 95% and preferably between 15% and 85%.

The blend of S-B diblock and S-B-M triblock is denoted hereinafter as SBM. This blend advantageously contains between 5% and 80% of S-B diblock for, respectively, from 95% to 20% of S-B-M triblock.

An advantage of these block compositions, SBM, is that it is not necessary to purify the S-B-M at the end of its synthesis. In other words, component (III), according to the present invention, may very well be a blend of S-B diblocks and S-B-M triblocks.

As described above, the transparency is obtained, in general, by applying the equation of equality of refractive indices of the components. Accordingly, according to one of the modes of the invention, that involving a matrix SM not additized with an impact additive, plus a block copolymer SBM, and giving consideration, as a nonexclusive example of the invention, to an amorphous random copolymer of styrene and methyl methacrylate as matrix SM and to a block copolymer of polystyrene, polybutadiene, and polymethyl methacrylate as copolymer SBM, the condition of equality of refractive indices gives the following:

n_{SM}=n_{SBM}, where the following laws are used for calculating the refractive indices of each polymer:
n_{SM}=v_{S}·n_{PS}+v_{M}·n_{PMMA}
n_{SM}=v_{PS}·n_{PS}+v_{PBd}·n_{PBd}+v_{PMMA}·n_{PMMA}
v_{S} and v_{M} are the volume fractions of the styrene and methyl methacrylate units in the copolymer SM,

v_{PS}, v_{PBd} and v_{PMMA} are the volume fractions of the polystyrene (PS), polybutadiene (PBd) and polymethyl methacrylate (PMMA) blocks of the SBM triblock,

and n_{PS}, n_{PBd} and n_{PMMA} are the refractive indices of polystyrene, polybutadiene, and poly(methyl methacrylate).

When, in addition to the matrix SM and the block copolymer SBM, a conventional impact additive is used in the composition, it must be selected such that its refractive index is equal to those of the matrix and of the block copolymer, within a tolerance limit of 0.01 difference.

The compositions of the invention may be obtained in a variety of ways. By way of indication mention may be made of the direct synthesis route and the blending or compounding route:

1) Synthesis route: This consists in synthesizing the random copolymer (SM) in the presence of the triblock. The product thus obtained is subsequently employed, after blending where appropriate with the third component (“core-shell” impact additive), or on its own, when it is not appropriate to modify the matrix with a “core-shell” impact additive. Extrusion is the preferred method of implementation, although other techniques such as calendering may be employed. Extrusion may be carried out in one or more steps, and the composition is obtained in the form of granules.

2) Compounding route: This consists in mixing the two or three components of the invention (SM+SBM+, where appropriate, the “core-shell” impact additive), synthesized separately beforehand, in a polymer-processing apparatus, typically an extruder which gives granules. The compounding route may comprise one or more processing (extrusion) steps;

when it involves blending the three components, it may be necessary or desirable to carry out two or more processing steps involving at least two of the components for the first step and the three components for the last step. Thus, for example, when two of the components are in a different physical form from the third (e.g., powder, powder, granules), it may be advantageous to premix two of the three components by extrusion, to give a mixture in the same physical form as the third component (e.g., granules). This first mixture of two components (granules) may then more easily be extruded with the third component (granules), the final result being, as for the synthesis route, granules of the composition of the invention.

After shaping by extrusion, calendering+grinding, or any other technique intended to constitute the composition of the invention, the granules obtained by one of the two possible routes may subsequently be converted, again by the known methods of shaping polymers (extrusion, injection molding, calendering, etc.), so as to give the final form of the manufactured object made of the material constituting the subject of the invention. As stated above, this final form is dictated by the applications in the construction, household electrical appliance, telephony or office automation sector, the automobile industry, or others.

The examples which follow illustrate the invention without limiting its scope.

Products to be Tested: Composition and Utilization

The composition of the 5 products used (four ternary mixtures SM+SBM+“core-shell” additive, and one control) for the evaluation is given in Table I. The control selected was extruded under the same conditions as for the ternary mixtures. The control is a mixture of 60% by weight of an SM copolymer of composition 45/55 (respective percentages by weight of styrene units and methyl methacrylate units in the copolymer) with 40% by weight of a “core-shell” additive (MBS), but without block copolymer. This mixture was produced by the applicant under the reference Oroglas TP327.

The components used to obtain the Oroglas TP327 control and the ternary mixtures, and also their origins, are described below:

Matrix SM: Random copolymer obtained by suspension polymerization, composed of 45% by weight of styrene and 55% by weight of methyl methacrylate.

Impact additive MBS: Conventional “core-shell” impact additive for PVC, produced and sold by Rohm & Haas under the reference Paraloid BTA 740.

Triblock SBM: Two triblocks were used, namely: SBM 654, and SBM 9.88. The two have molecular masses of the polystyrene block of between 20 000 and 30 000 g/mol and respective overall compositions (determined by ¹H NMR) of 35/31/34 and 31/38/31, as percentages by weight of polystyrene/polybutadiene/polymethyl methacrylate, 60% syndiotactic.

Antioxidant: 0.1% by weight (relative to the mixture) of Irganox 1076 (Ciba) was added to all the products.

TABLE I
Compositions of the products for testing

| Reference | 1 | 2 | 3 | 4 | 5 |
|---|---|---|---|---|---|
| Components | Control | | | | |
| ? | ’Oroglas | | | | |
| | TP327' | | | | |
| SM (powder) | 60% wt | 60% wt | 60% wt | 60% wt | 50% wt |
| MBS (powder) | 40% wt | 25% wt | 25% wt | 20% wt | 35% wt |
| SBM654 | | 15% wt | | | |
| (powder/ | | | | | |
| granules) | | | | | |
| SBM 9.88 | | | 15% wt | 20% wt | 15% wt |
| (granules) | | | | | |
| Irganox 1076 | 0.1% wt | 0.1% wt | 0.1% wt | 0.1% wt | 0.1% wt |

The products of Table I were processed in a Werner 30 extruder with a screw profile rotating at 300 rpm. At the extruder outlet a head with two holes 2 (mm) in diameter was installed. The setpoint temperatures in the various zones are summarized in Table II. Following extrusion, the extrudates dipped into a cooling tank of water and then passed into a granulator.

TABLE II
Thermal profile for extrusion in the Werner 30

| Tz1 | Tz2 | Tz3 | Tz4 | Tz5 | Tz6 | Tz7 | T head |
|---|---|---|---|---|---|---|---|
| (° C.) | (° C.) | (° C.) | (° C.) | (° C.) | (° C.) | (° C.) | (° C.) |
| 250 | 250 | 240 | 230 | 220 | 210 | 200 | 200 |

With these conditions, the extrusion torque (on a scale of % of a maximum value), three intermediate temperature measurements, the temperature at the extruder head, and the pressure at the outlet were recorded. The lower the torque and the pressure, the more fluid the product. Table III summarizes the measurements made for each extrusion.

TABLE III
Temperature, pressure and extrusion torque measurements

| Reference | TM1 | TM2 | TM3 | TM (head) | | Torque |
|---|---|---|---|---|---|---|
| | (° C.) | (° C.) | (° C.) | (° C.) | P (bar) | (%) |
| 1 | 280 | 246 | 237 | 212 | 22 | 57-59 |
| 2 | 283 | 245 | 240 | 210 | 21 | 53-56 |
| 3 | 276 | 250 | 246 | 213 | 19 | 56-58 |
| 4 | 276 | 249 | 239 | 210 | 20 | 56-59 |
| 5 | 279 | 250 | 243 | 210 | 25 | 64-66 |

The pressure and torque values are fairly stable and sensitive to the fluidity of the product. The reductions in pressure and torque for ternary mixtures 2 and 3 (relative to the control) were noted as soon as the change of product took place in the extruder. In any case, with a constant amount of SBM+“core-shell” MBS (40%), the mixtures containing the triblock are, at the worst, as fluid as the Oroglas TP327 control.

Definition of the Tests

Standardized plaques and test specimens were obtained by injection molding the extruded granules. The tests employed were as follows:

notched Charpy impact at ambient temperature (23° C.) and at low temperature (−30° C.)

flexural moduli

conventional flexural stress (end of the elastic zone)

% transmittance 3 mm

Vicat temperature

Results

Table IV presents the results of the mechanical tests for each of the products of Table I.

Table V shows the measurements of the optical properties. The optical measurements are carried out in a spectrocolorimeter (D65 illuminant, observation angle 2°, values recorded as 560 nm) on plaques measuring 100×100×3 mm.

Table VI shows the measurements of the Vicat point (measurement of the heat resistance of the samples) for each of the products of Table I.

TABLE IV
Mechanical properties and impact resistance tests

| | | Refer- | Refer- | Refer- | Refer- | Refer- |
|---|---|---|---|---|---|---|
| Test/ | | ence | ence | ence | ence | ence |
| property | Units | 1 (control) | 2 | 3 | 4 | 5 |
| | | n = 5 | n = 5 | n = 5 | n = 5 | n = 5 |
| Flexural | MPa | 1648 | 1846 | 1797 | 1831 | 1479 |
| modulus | | | | | | |
| Standard | MPa | 17 | 12 | 13 | 15 | 4 |
| deviation | | | | | | |
| Conventional | MPa | 46.2 | 51.9 | 50.7 | 51.2 | 41.0 |
| stress | | | | | | |
| Standard | MPa | 0.3 | 0.3 | 0.3 | 0.3 | 0.3 |
| deviation | | | | | | |
| T = 23° C. | | n = 10 | n = 10 | n = 10 | n = 10 | n = 10 |
| Average | kJ/m² | 7.2 | 6.2 | 9.8 | 8.7 | 12.1 |
| resilience | | | | | | |
| (notched | | | | | | |
| Charpy test) | | | | | | |
| Standard | kJ/m² | 0.2 | 0.4 | 1.9 | 0.6 | 0.8 |
| deviation | | | | | | |
| Type of | | C | C | C | C | C |
| fracture | | | | | | |
| Percentage of | | | | | | |
| fracture | % | 100 | 100 | 100 | 100 | 100 |
| T = −30° C. | | n = 10 | n = 10 | n = 10 | n = 10 | n = 10 |
| Average | kJ/m² | 1.4 | 2.5 | 3.0 | 4.5 | 7.7 |
| resilience | | | | | | |
| (notched | | | | | | |
| Charpy test) | | | | | | |
| Standard | kJ/m² | 0.1 | <0.1 | 0.4 | 0.1 | 0.7 |
| deviation | | | | | | |
| Type of | | C | C | C | C | C |
| fracture | | | | | | |
| Percentage of | % | 100 | 100 | 100 | 100 | 100 |
| fracture | | | | | | |

In all the cases, the control, Oroglas TP 327 (produced under the same processing conditions as the ternary mixtures), was tested with the four ternary mixtures in order to have an internal reference in the event of shifting of the evaluation scales. This was particularly useful for the test of optical properties, since, in general, the transmission values obtained are rather low (including that for the control). This shift in scale for the transmission, which effects all of the products, may originate in the conditions employed for the implementation, which are not optimized.

TABLE V
Optical measurements

| | % transmission | Standard |
|---|---|---|
| Sample No. | (sphere side) | deviation |
| 1 | 85.7 | 0.3 |
| 2 | 84.5 | 0.2 |
| 3 | 83.3 | 0.1 |
| 4 | 80.2 | 0.3 |
| 5 | 83.5 | 1 |

TABLE VI
Heat resistance

| Vicat point | Control 1 | 2 | 3 | 4 | 5 |
|---|---|---|---|---|---|
| ISO 306: | Oroglas | 60/25/15 | 60/25/15 | 60/20/20 | 50/35/15 |
| 94-B 50 | TP327 | SBM 654 | SBM 9.88 | SBM 9.88 | SBM 9.88 |
| [50° C./ | n = 4 | n = 4 | n = 4 | n = 4 | n = 4 |
| H-50 N] | | | | | |
| Vicat point | 79.1 | 83.0 | 82.5 | 83.3 | 76.7 |
| (° C.) | | | | | |
| Standard | 0.9 | 0.9 | 0.9 | 0.7 | 0.6 |
| deviation | | | | | |
| (° C.) | | | | | |

Tables IV, V, and VI allow comparison of mechanical and impact strength properties, and also of the heat resistance properties, of the ternary mixtures SM/SBM/“core-shell” additive, which constitute one mode of the invention, relative to a thermoplastic amorphous matrix SM modified with a conventional “core-shell” impact additive but not containing a block copolymer. In terms of mechanical modulus and flexural stress at the limit of the elastic zone it is clear, according to Table IV, that the ternary mixtures 2, 3, and 4 are superior to the control. Mixture 5 is not directly comparable with the same control, since its composition includes a lower amount of matrix SM. In terms of impact strength, this same Table IV also shows the superiority of the ternary mixtures 3, 4, and 5, relative to the control at ambient temperature, and of all the ternary mixtures, relative to the control at −30° C. Ternary mixture 5 is not directly comparable with the control, since it contains less of matrix SM (this explains, in part, why it has the greatest impact strength), but the other ternary mixtures, and particularly mixtures 3 and 4, combine—in accordance with the object of the invention—a rigidity (mechanical modulus) greater than that of the control, with an imp ct strength which is also improved. Table V shows that the relative transparency of the ternary mixtures, relative to the control, is comparable (very slightly lower) for all of the mixtures with the exception of mixture 5, which, once again, is not directly comparable with the control. Finally, Table VI shows that, for all of the ternary mixtures, with the exception of mixture 5, the heat resistance (Vicat point) of the materials is improved relative to that of the control. Even mixture 5, which contains a lower amount of matrix SM, which ought to lower its heat resistance greatly, presents a value close to that of the control, which contains more matrix.

These examples show that the composition found by the applicant, according to one of the modes of the invention (that of the three-component mixtures: amorphous thermoplastic polymeric matrix/block copolymer/conventional “core-shell” impact additive), is able to combine the characteristics of a mechanical modulus (rigidity) equal to or greater than, and an impact resistance equal to or greater than, those of an amorphous thermoplastic polymeric matrix modified simply by a conventional impact additive. This surprising combination is obtained without notable deterioration in the transparency of the materials and with, furthermore, a significant improvement in their heat resistance.

Table VII compares the properties of mechanical modulus and of breaking energy (associated with impact strength) measured in slow traction (3 mm/min) on compositions comprising, according to another mode of the invention (that of the binary systems: amorphous thermoplastic polymeric matrix/block copolymer), a matrix SM and a copolymer SBM, relative to the matrix SM on its own without impact modification. These systems were obtained by the synthesis route described above, which means that the matrix SM was synthesized by suspension polymerization in the presence of the SBM triblock. Table VII shows that, in the absence of conventional impact additive of “core-shell” type, the block copolymer is able to provide the thermoplastic amorphous matrix with the target combination of a high mechanical modulus and an improved impact strength.

TABLE VII
Moduli and breaking energies for systems not modified
with a “core-shell” impact additive

| | | Triblock used SBM 654 | | | | |
|---|---|---|---|---|---|---|
| | SM 45% | with composition of | | | | |
| | by weight | 35/31/34 in % by weight | | | E | |
| | of styrene | of PS/PBd/ | σ_{threshold} | ε_{break} | modulus | E_{break} |
| Product | units | PMMA | (MPa) | (MPa) | (GPa) | (mJ) |
| SA7 | 45/55 | 0 | 52.3 | 4 | 1.75 | 255 |
| SA12 | 45/55 | 10% SBM 654 | 73.42 | 15.98 | 2.02 | 1303 |
| SA18 | 45/55 | 20% SBM 654 | 71.15 | 29.25 | 2.01 | 2379 |

1. A transparent polymeric composition having good impact strength, a high modulus, and good heat resistance, comprising:
from 50% to 90% by weight of a thermoplastic matrix (I) with a refractive index n₁, wherein matrix (I) is a homopolymer or a copolymer comprising at least one monomer unit selected from the group consisting of styrene, acrylonitrile, acrylic acid, and short-chain alkyl (meth)acrylates;
from 0 to 40% by weight of an impact additive (II) with a refractive index n₂; and
from 10% to 50% by weight of a block copolymer (III) with a refractive index n₃;
the difference between the refractive indices, taken two by two, being less than or equal to 0.01.

2. The composition of claim 1, wherein the block copolymer III conforms to the following general formula -Y-B-Y′- in which
B is an elastomer block which is thermodynamically incompatible with blocks Y and Y′,
Y and Y′ can be the same or different,
at least one of the two blocks Y and Y′ is totally or partially compatible with the thermoplastic matrix (I).

3. The composition of claim 2, wherein B comprises one or more monomer units selected from the group consisting of butadiene, isoprene, 2,3-dimethyl-1,3-butadiene, 1,3-pentadiene and 2-phenyl-1,3-butadiene.

4. The composition of claim 3, wherein B comprises butadiene monomer units.

5. The composition of claim 3, wherein B comprises isoprene monomer units.

6. The composition of claim 2, wherein Y and Y′ comprise at least one monomer unit selected from the group consisting of styrene and short-chain alkyl methacrylates.

7. The composition of claim 6, wherein Y is a block composed predominantly of styrene and wherein Y′ is a block composed predominantly of methyl methacrylate monomer units.

8. The composition of claim 6, wherein Y and Y′ are blocks composed predominantly of methyl methacrylate monomer units.

9. The composition of claim 7, wherein Y′ comprises at least 60% of syndiotactic polymethyl methacrylate.

10. The composition of claim 8, wherein Y and Y′ each contain at least 60% of syndiotactic polymethyl methacrylate.

11. The composition of claim 1, wherein the amorphous matrix I comprises at least one monomer unit selected from the group consisting of styrene, acrylonitrile, acrylic acid, and short-chain alkyl (meth)acrylates.

12. The composition of claim 11, wherein I comprises a mixture composed of 0 to 55% by weight of styrene monomer units and from 45% to 100% by weight of methyl methacrylate monomer units.

13. The composition of claim 1, wherein the additive II is a core-shell copolymer comprising an elastomer core and a rigid shell which is compatible with the amorphous matrix I.

14. An article comprising the composition of claim 1, wherein said article is formed by a melt state conversion selected from the group consisting of injection molding, extrusion and calendaring.

15. The composition of claim 6, wherein Y and Y′ comprise methyl methacrylate units.

16. The composition of claim 11, wherein the amorphous matrix I comprises methyl methacrylate monomer units.
